(19) United States
(12) Patent Application Publication
(10) Pub. No.: US 2020/0211440 A1
(43) Pub. Date: Jul. 2, 2020

(54) METHOD OF DRIVING A DISPLAY DEVICE AND DISPLAY DEVICE EMPLOYING THE SAME

(71) Applicant: Samsung Display Co., Ltd., Yongin-si (KR)

(72) Inventors: Joo-Young LEE, Hwaseong-si (KR); Young Nam YUN, Suwon-si (KR)

(21) Appl. No.: 16/701,452

(22) Filed: Dec. 3, 2019

(30) Foreign Application Priority Data
Dec. 31, 2018 (KR) 10-2018-0173633

(51) Int. Cl. G09G 3/20; G09G 3/3233; G06F 1/16

(52) U.S. Cl. CPC G09G 3/2003; G09G 3/3233; G06F 1/1652; G09G 2320/068; G09G 2354/00; G09G 2320/0242; G09G 2300/0452; G09G 2320/0666; G09G 2320/028

(57) ABSTRACT

A method of driving a foldable display device, which includes a first display panel and a second display panel that are foldable onto each other, includes detecting a first gaze angle of a viewer with respect to the first display panel and a second gaze angle of the viewer with respect to the second display panel, determining a first red, green, blue (RGB) luminance ratio corresponding to the first gaze angle and a second RGB luminance ratio corresponding to the second gaze angle based on a mapping table that stores expected gaze angles and optimal RGB luminance ratios mapped to the expected gaze angles, performing a first color shifting operation on the first display panel based on the first RGB luminance ratio, and performing a second color shifting operation on the second display panel based on the second RGB luminance ratio.

### CROSS-REFERENCE TO RELATED APPLICATION

This application claims priority to and the benefit of Korean Patent Application No. 10-2018-0173633, filed on Dec. 31, 2018 in the Korean Intellectual Property Office (KIPO), the content of which is incorporated herein in its entirety by reference.

### BACKGROUND

### 1. Field

Aspects of the present inventive concept relate to a display device.

### 2. Description of the Related Art

Generally, depending on the direction (or a viewing angle) in which a viewer (or user) gazes at a display panel, a path, reflectance, and the like of light output from pixels included in the display panel may be changed, and thus a wavelength (i.e., color) of the light may also be changed. Thus, a color shift phenomenon (e.g., white angular dependency (WAD), etc.) may occur by which a color of an image displayed on the display panel is changed according to the direction in which the viewer gazes at the display panel. For example, when the viewer gazes at the display panel from the front of the display panel, the color shift phenomenon may not occur. On the other hand, when the viewer gazes at the display panel from the side of the display panel, the color shift phenomenon may occur (e.g., the image displayed on the display panel may become reddish, greenish, or bluish). For this reason, a conventional method prevents (or reduces) the color shift phenomenon by changing red, green, blue (RGB) target color coordinates or a resonance structure of the display panel. However, when the conventional method changes the RGB target color coordinates, a color gamut (or color reproduction range) may be degraded. In addition, when the conventional method changes the resonance of the display panel, not only a manufacturing yield may be reduced but also there is a limit due to manufacturing process distribution as a manufacturing process becomes complicated. Recently, a foldable display device including a first display panel and a second display panel that are foldable onto each other has been spotlighted because the viewer can use the foldable display device as a book. In case of the foldable display device including the first and second display panels, when the viewer gazes at the foldable display device from the front of the foldable display device, the viewer may gaze at the first display panel from the side of the first display panel and may gaze at the second display panel from the side of the second display panel. In addition, because a folding angle between the first display panel and the second display panel may be continuously changed by the viewer in the foldable display device, the user may frequently experience the color shift phenomenon.

### SUMMARY

Aspects of embodiments of the present inventive concept are directed to a method of driving a foldable display device that includes a first display panel and a second display panel that are foldable onto each other, and can effectively prevent (or reduce) a color shift phenomenon by which a color of an image displayed on the display device is changed according to a direction in which a viewer gazes at the display device.

Aspects of embodiments of the present inventive concept are directed to a display device employing said method.

According to some example embodiments, there is provided a method of driving a foldable display device including a first display panel and a second display panel that are foldable onto each other, the method including: detecting a first gaze angle of a viewer with respect to the first display panel and a second gaze angle of the viewer with respect to the second display panel; determining a first red, green, blue (RGB) luminance ratio corresponding to the first gaze angle and a second RGB luminance ratio corresponding to the second gaze angle based on a mapping table that stores expected gaze angles and optimal RGB luminance ratios mapped to the expected gaze angles; performing a first color shifting operation on the first display panel based on the first RGB luminance ratio; and performing a second color shifting operation on the second display panel based on the second RGB luminance ratio.

In some embodiments, the detecting the first gaze angle includes: detecting a first gaze of the viewer with respect to the first display panel; and determining the first gaze angle as an angle between a normal line of the first display panel and the first gaze.

In some embodiments, the detecting the first gaze angle includes: sensing a folding angle between the first display panel and the second display panel using at least one sensing device; and calculating the first gaze angle based on the folding angle.

In some embodiments, the detecting the second gaze angle includes: detecting a second gaze of the viewer with respect to the second display panel; and determining the second gaze angle as an angle between a normal line of the second display panel and the second gaze.

In some embodiments, the detecting the second gaze angle includes: sensing a folding angle between the first display panel and the second display panel using at least one sensing device; and calculating the second gaze angle based on the folding angle.

In some embodiments, determining the first RGB luminance ratio includes: searching for a first optimal RGB luminance ratio mapped to a first expected gaze angle that corresponds to the first gaze angle in the mapping table; and choosing the first optimal RGB luminance ratio as the first RGB luminance ratio.

In some embodiments, determining the second RGB luminance ratio includes: searching for a second optimal RGB luminance ratio mapped to a second expected gaze angle that corresponds to the second gaze angle in the mapping table; and choosing the second optimal RGB luminance ratio as the second RGB luminance ratio.

In some embodiments, the performing the first color shifting operation includes: determining a compensated red color luminance, a compensated green color luminance, and a compensated blue color luminance by applying weighted values to a red color luminance, a green color luminance, and a blue color luminance of the first display panel according to the first RGB luminance ratio; adjusting first currents flowing through organic light-emitting elements of red color display pixels of the first display panel to implement the compensated red color luminance; adjusting second currents flowing through organic light-emitting elements of green color display pixels of the first display panel to implement the compensated green color luminance; and adjusting third currents flowing through organic light-emitting elements of blue color display pixels of the first display panel to implement the compensated blue color luminance.

In some embodiments, the performing the first color shifting operation includes: determining a compensated red color luminance, a compensated green color luminance, and a compensated blue color luminance by applying weighted values to a red color luminance, a green color luminance, and a blue color luminance of the first display panel according to the first RGB luminance ratio; compensating first data to be applied to red color display pixels of the first display panel to implement the compensated red color luminance; compensating second data to be applied to green color display pixels of the first display panel to implement the compensated green color luminance; and compensating third data to be applied to blue color display pixels of the first display panel to implement the compensated blue color luminance.

In some embodiments, the performing the second color shifting operation includes: determining a compensated red color luminance, a compensated green color luminance, and a compensated blue color luminance by applying weighted values to a red color luminance, a green color luminance, and a blue color luminance of the second display panel according to the second RGB luminance ratio; adjusting first currents flowing through organic light-emitting elements of red color display pixels of the second display panel to implement the compensated red color luminance; adjusting second currents flowing through organic light-emitting elements of green color display pixels of the second display panel to implement the compensated green color luminance; and adjusting third currents flowing through organic light-emitting elements of blue color display pixels of the second display panel to implement the compensated blue color luminance.

In some embodiments, the performing the second color shifting operation includes: determining a compensated red color luminance, a compensated green color luminance, and a compensated blue color luminance by applying weighted values to red color luminance, a green color luminance, and a blue color luminance of the second display panel according to the second RGB luminance ratio; compensating first data to be applied to red color display pixels of the second display panel to implement the compensated red color luminance; compensating second data to be applied to green color display pixels of the second display panel to implement the compensated green color luminance; and compensating third data to be applied to blue color display pixels of the second display panel to implement the compensated blue color luminance.

According to some example embodiments, there is provided a method of driving a display device including: detecting a gaze angle of a viewer with respect to a display panel; determining a red, green, blue (RGB) luminance ratio corresponding to the gaze angle based on a mapping table that stores expected gaze angles and optimal RGB luminance ratios mapped to the expected gaze angles; and performing a color shifting operation on the display panel based on the RGB luminance ratio.

In some embodiments, the performing the color shifting operation includes: determining a compensated red color luminance, a compensated green color luminance, and a compensated blue color luminance by applying weighted values to a red color luminance, a green color luminance, and a blue color luminance of the display panel according to the RGB luminance ratio; adjusting first currents flowing through organic light-emitting elements of red color display pixels of the display panel to implement the compensated red color luminance; adjusting second currents flowing through organic light-emitting elements of green color display pixels of the display panel to implement the compensated green color luminance; and adjusting third currents flowing through organic light-emitting elements of blue color display pixels of the display panel to implement the compensated blue color luminance.

In some embodiments, the performing the color shifting operation includes: determining a compensated red color luminance, a compensated green color luminance, and a compensated blue color luminance by applying weighted values to a red color luminance, a green color luminance, and a blue color luminance of the display panel according to the RGB luminance ratio; compensating first data to be applied to red color display pixels of the display panel to implement the compensated red color luminance; compensating second data to be applied to green color display pixels of the display panel to implement the compensated green color luminance; and compensating third data to be applied to blue color display pixels of the display panel to implement the compensated blue color luminance.

According to some example embodiments, there is provided a display device including: a foldable display panel including a first display panel and a second display panel that are foldable onto each other; a display panel driving circuit configured to drive the first display panel and the second display panel; a memory device configured to record a mapping table that stores expected gaze angles and optimal red, green, blue (RGB) luminance ratios mapped to the expected gaze angles; and a color shift executing circuit configured to detect a first gaze angle of a viewer with respect to the first display panel and a second gaze angle of the viewer with respect to the second display panel, to determine a first RGB luminance ratio corresponding to the first gaze angle and a second RGB luminance ratio corresponding to the second gaze angle based on the mapping table, to perform a first color shifting operation on the first display panel based on the first RGB luminance ratio, and to perform a second color shifting operation on the second display panel based on the second RGB luminance ratio.

In some embodiments, the color shift executing circuit includes a face recognition sensor configured to sense a face of the viewer and an iris recognition sensor configured to sense an iris of the viewer, and wherein the color shift executing circuit detects the first and second gaze angles based on a gaze direction of the face sensed by the face recognition sensor and a location of the iris sensed by the iris recognition sensor.

In some embodiments, the color shift executing circuit includes a gyro sensor configured to sense a folding angle between the first display panel and the second display panel, and wherein the color shift executing circuit is configured to detect the first and second gaze angles based on the folding angle between the first display panel and the second display panel.

In some embodiments, the color shift executing circuit is configured not to operate in an unfolded display mode in which a folding angle between the first display panel and the second display panel is 180° or when an image is displayed on either the first display panel or the second display panel.

In some embodiments, the color shift executing circuit is configured to determine a compensated red color luminance, a compensated green color luminance, and a compensated blue color luminance by applying weighted values to a red color luminance, a green color luminance, and a blue color luminance of the first display panel according to the first RGB luminance ratio, to adjust first currents flowing through organic light-emitting elements of red color display pixels of the first display panel or to compensate first data to be applied to the red color display pixels to implement the compensated red color luminance, to adjust second currents flowing through organic light-emitting elements of green color display pixels of the first display panel or to compensate second data to be applied to the green color display pixels to implement the compensated green color luminance, and to adjust third currents flowing through organic light-emitting elements of blue color display pixels of the first display panel or to compensate third data to be applied to the blue color display pixels to implement the compensated blue color luminance.

In some embodiments, the color shift executing circuit is configured to determine a compensated red color luminance, a compensated green color luminance, and a compensated blue color luminance by applying weighted values to a red color luminance, a green color luminance, and a blue color luminance of the second display panel according to the second RGB luminance ratio, to adjust first currents flowing through organic light-emitting elements of red color display pixels of the second display panel or to compensate first data to be applied to the red color display pixels to implement the compensated red color luminance, to adjust second currents flowing through organic light-emitting elements of green color display pixels of the second display panel or to compensate second data to be applied to the green color display pixels to implement the compensated green color luminance, and to adjust third currents flowing through organic light-emitting elements of blue color display pixels of the second display panel or to compensate third data to be applied to the blue color display pixels to implement the compensated blue color luminance.

Therefore, a method of driving a foldable display device that includes a first display panel and a second display panel that are foldable onto each other, may effectively prevent (or reduce) a color shift phenomenon, by which a color of an image displayed on the display device is changed according to a direction in which a viewer gazes at the display device. This is achieved by detecting a first gaze angle of the viewer with respect to the first display panel and a second gaze angle of the viewer with respect to the second display panel, by determining a first RGB luminance ratio corresponding to the first gaze angle of the viewer and a second RGB luminance ratio corresponding to the second gaze angle of the viewer based on a mapping table that stores expected gaze angles and optimal RGB luminance ratios mapped to the expected gaze angles, by performing a first color shifting operation on the first display panel based on the first RGB luminance ratio, and by performing a second color shifting operation on the second display panel based on the second RGB luminance ratio.

In addition, a display device according to some example embodiments may provide a high-quality image to a viewer (or user) by employing the method.

### BRIEF DESCRIPTION OF THE DRAWINGS

Illustrative, non-limiting example embodiments will be more clearly understood from the following detailed description in conjunction with the accompanying drawings.

FIG. 1 is a flow diagram illustrating a method of driving a display device according to some example embodiments.

FIG. 2 is a diagram illustrating an example in which a gaze angle is detected by the method of FIG. 1.

FIG. 3 is a diagram illustrating another example in which a gaze angle is detected by the method of FIG. 1.

FIG. 4 is a flow diagram illustrating an example in which a color shifting operation is performed by the method of FIG. 1.

FIG. 5 is a flow diagram illustrating another example in which a color shifting operation is performed by the method of FIG. 1.

FIG. 6 is a flow diagram illustrating a method of driving a display device according to some example embodiments.

FIG. 7 is a block diagram illustrating a display device according to some example embodiments.

FIG. 8 is a diagram illustrating display modes of the display device of FIG. 7.

FIG. 9 is a block diagram illustrating an electronic device according to some example embodiments.

FIG. 10 is a diagram illustrating an example in which the electronic device of FIG. 9 is implemented as a smart pad.

### DETAILED DESCRIPTION

Hereinafter, embodiments of the present inventive concept will be explained in detail with reference to the accompanying drawings.

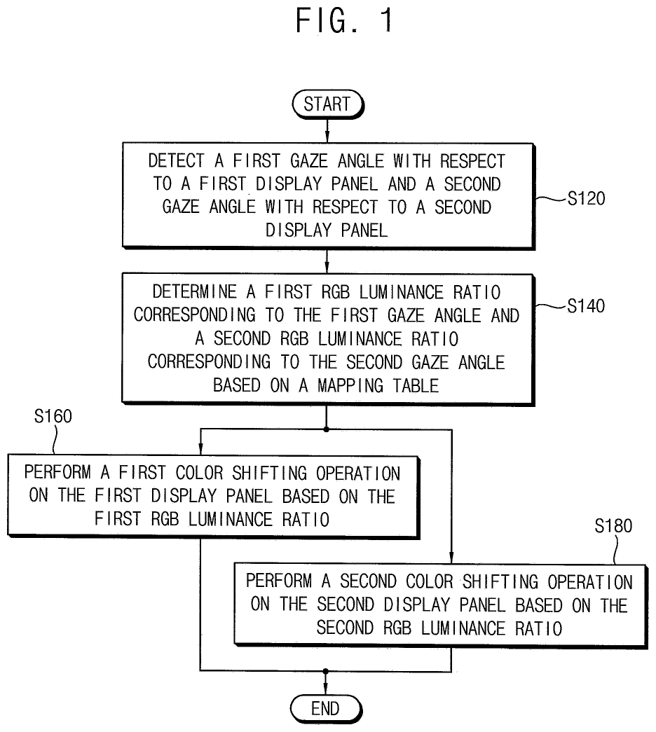

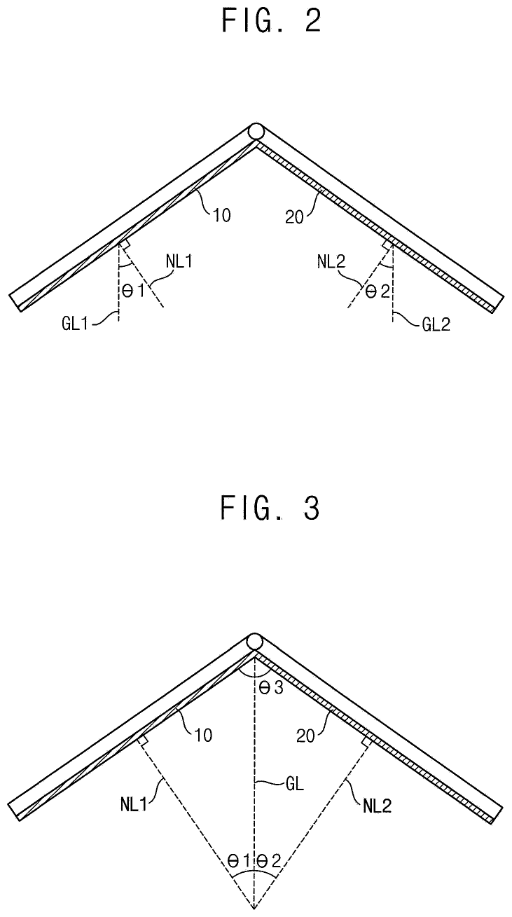

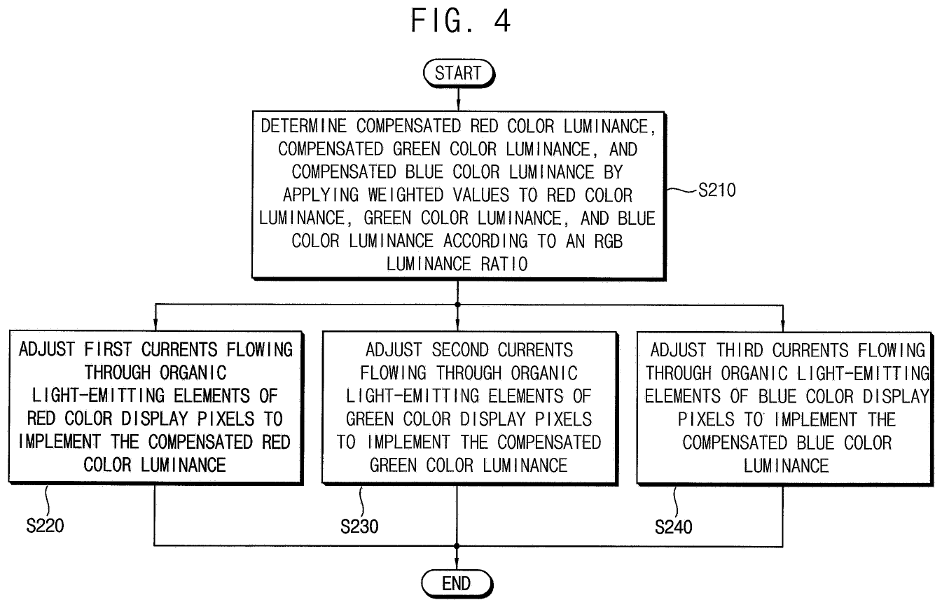

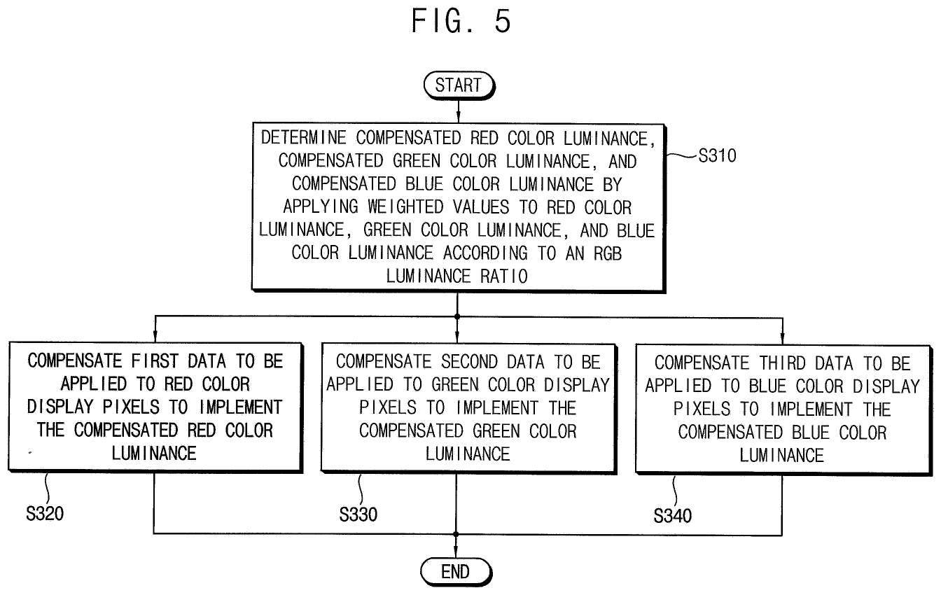

FIG. 1 is a flow diagram illustrating a method of driving a display device according to some example embodiments; FIG. 2 is a diagram illustrating an example in which a gaze angle is detected by the method of FIG. 1; FIG. 3 is a diagram illustrating another example in which a gaze angle is detected by the method of FIG. 1; FIG. 4 is a flow diagram illustrating an example in which a color shifting operation is performed by the method of FIG. 1; and FIG. 5 is a flow diagram illustrating another example in which a color shifting operation is performed by the method of FIG. 1.

Referring to FIGS. 1 to 5, the method of FIG. 1 may drive a display device (e.g., a foldable display device) including a first display panel 10 and a second display panel 20 that are foldable onto each other. For example, the method of FIG. 1 may detect a first gaze angle θ1 of a viewer with respect to the first display panel 10 and a second gaze angle θ2 of the viewer with respect to the second display panel 20 (S120), may determine a first red, green, blue (RGB) luminance ratio corresponding to the first gaze angle θ1 of the viewer and a second RGB luminance ratio corresponding to the second gaze angle θ2 of the viewer based on a mapping table that stores expected gaze angles and optimal RGB luminance ratios mapped to the expected gaze angles (S140), may perform a first color shifting operation on the first display panel 10 based on the first RGB luminance ratio (S160), and may perform a second color shifting operation on the second display panel 20 based on the second RGB luminance ratio (S180).

The method of FIG. 1 may detect the first gaze angle θ1 of the viewer with respect to the first display panel 10 and the second gaze angle θ2 of the viewer with respect to the second display panel 20 (S120). In an example embodiment, as illustrated in FIG. 2, the method of FIG. 1 may detect a first gaze GL1 of the viewer with respect to the first display panel 10 and may determine the first gaze angle θ1 of the viewer as an angle between a normal line NL1 of (e.g., a line normal/orthogonal to) the first display panel 10 and the first gaze GL1 of the viewer. Similarly, as illustrated in FIG. 2, the method of FIG. 1 may detect a second gaze GL2 of the viewer with respect to the second display panel 20 and may determine the second gaze angle θ2 of the viewer as an angle between a normal line NL2 of the second display panel 20 and the second gaze GL2 of the viewer. Here, the first and second gazes GL1 and GL2 of the viewer may be detected by a face recognition sensor that senses a face of the viewer and an iris recognition sensor that senses iris of the viewer. For example, the method of FIG. 1 may detect the first and second gazes GL1 and GL2 of the viewer by reflecting a location of the iris sensed by the iris recognition sensor on a gaze direction of the face sensed by the face recognition sensor, where the face recognition sensor and the iris recognition sensor are included in the display device. In another example embodiment, as illustrated in FIG. 3, the method of FIG. 1 may sense a folding angle θ3 between the first display panel 10 and the second display panel 20 using at least one sensing device (e.g., a gyro sensor, and/or the like) and may calculate the first gaze angle θ1 of the viewer based on the folding angle θ3 between the first display panel 10 and the second display panel 20. For example, the first gaze angle θ1 of the viewer may be calculated as 90−½×θ3. However, calculation of the first gaze angle θ1 of the viewer is not limited thereto. Similarly, as illustrated in FIG. 2, the method of FIG. 1 may sense the folding angle θ3 between the first display panel 10 and the second display panel 20 using at least one sensing device and may calculate the second gaze angle θ2 of the viewer based on the folding angle θ3 between the first display panel 10 and the second display panel 20. For example, the second gaze angle θ2 of the viewer may be calculated as 90−½×θ3. However, calculation of the second gaze angle θ2 of the viewer is not limited thereto.

Next, the method of FIG. 1 may determine the first RGB luminance ratio corresponding to the first gaze angle θ1 of the viewer and the second RGB luminance ratio corresponding to the second gaze angle θ2 of the viewer based on the mapping table that stores the expected gaze angles and the optimal RGB luminance ratios mapped to the expected gaze angles (S140). Here, the RGB luminance ratio indicates a ratio between a red color luminance, a green color luminance, and a blue color luminance that are mixed to implement (e.g., generate) a white color having a specific luminance. Thus, a red color may be weakened (e.g., less prominently visible/perceivable) when a ratio of the red color luminance is lowered in the RGB luminance ratio, a green color may be weakened when a ratio of the green color luminance is lowered in the RGB luminance ratio, and a blue color may be weakened when a ratio of the blue color luminance is lowered in the RGB luminance ratio. If the red color is stronger (e.g., more prominently visible/perceivable) in an image when the viewer gazes at the display panel 10/20 from the side of the display panel 10/20 than when the viewer gazes at the display panel 10/20 from the front of the display panel 10/20, the method of FIG. 1 may prevent (or reduce) a color shift phenomenon that occurs when the viewer gazes at the display panel 10/20 from the side of the display panel 10/20 by lowering the ratio of the red color luminance in the RGB luminance ratio when the viewer gazes at the display panel 10/20 from the side of the display panel 10/20. If the green color is stronger in an image when the viewer gazes at the display panel 10/20 from the side of the display panel 10/20 than when the viewer gazes at the display panel 10/20 from the front of the display panel 10/20, the method of FIG. 1 may prevent (or reduce) the color shift phenomenon that occurs when the viewer gazes at the display panel 10/20 from the side of the display panel 10/20 by lowering the ratio of the green color luminance in the RGB luminance ratio when the viewer gazes at the display panel 10/20 from the side of the display panel 10/20. If the blue color is stronger in an image when the viewer gazes at the display panel 10/20 from the side of the display panel 10/20 than when the viewer gazes at the display panel 10/20 from the front of the display panel 10/20, the method of FIG. 1 may prevent (or reduce) the color shift phenomenon that occurs when the viewer gazes at the display panel 10/20 from the side of the display panel 10/20 by lowering the ratio of the blue color luminance in the RGB luminance ratio when the viewer gazes at the display panel 10/20 from the side of the display panel 10/20.

As described above, the method of FIG. 1 may use the mapping table that stores the expected gaze angles and the optimal RGB luminance ratios mapped to the expected gaze angles when determining the first RGB luminance ratio for performing the first color shifting operation on the first display panel 10 and the second RGB luminance ratio for performing the second color shifting operation on the second display panel 20. Here, because the expected gaze angles and the optimal RGB luminance ratios mapped to the expected gaze angles are data obtained by the manufacturer of a display device by performing a simulation analysis, a test analysis, and/or the like on the display device (e.g., by performing a color deviation matching for an image viewed from the side with respect to an image viewed from the front and then by performing an RGB luminance ratio deviation matching for the image viewed from the side with respect to the image viewed from the front), the mapping table that stores the expected gaze angles and the optimal RGB luminance ratios mapped to the expected gaze angles may be included in a memory device of the display device when the display device is manufactured. In an example embodiment, the method of FIG. 1 may search for a first optimal RGB luminance ratio mapped to a first expected gaze angle that corresponds to (e.g., matches or is consistent) with the first gaze angle θ1 of the viewer in the mapping table and may choose the first optimal RGB luminance ratio as the first RGB luminance ratio for performing the first color shifting operation on the first display panel 10. In example embodiments, when there is not the first expected gaze angle that corresponds to (e.g., matches or is consistent with) the first gaze angle θ1 of the viewer in the mapping table, an interpolation technique may be employed. In addition, the method of FIG. 1 may search for a second optimal RGB luminance ratio mapped to a second expected gaze angle that corresponds to (e.g., matches or is consistent with) the second gaze angle θ2 of the viewer in the mapping table and may choose the second optimal RGB luminance ratio as the second RGB luminance ratio for performing the second color shifting operation on the second display panel 20. In example embodiments, when there is not the second expected gaze angle that corresponds to (e.g., matches or is consistent with) the second gaze angle θ2 of the viewer in the mapping table, the interpolation technique may also be employed.

Subsequently, the method of FIG. 1 may perform the first color shifting operation on the first display panel 10 based on the first RGB luminance ratio (S160) and may perform the second color shifting operation on the second display panel 20 based on the second RGB luminance ratio (S180). In an example embodiment, as illustrated in FIG. 4, the method of FIG. 1 may determine a compensated red color luminance, a compensated green color luminance, and a compensated blue color luminance by applying weighted values to the red color luminance, the green color luminance, and the blue color luminance of the first display panel 10 according to the first RGB luminance ratio (S210), may adjust first currents flowing through organic light-emitting elements of red color display pixels of the first display panel 10 to implement (e.g., generate) the compensated red color luminance (S220), may adjust second currents flowing through organic light-emitting elements of green color display pixels of the first display panel 10 to implement (e.g., generate) the compensated green color luminance (S230), and may adjust third currents flowing through organic light-emitting elements of blue color display pixels of the first display panel 10 to implement (e.g., generate) the compensated blue color luminance (S240). Similarly, as illustrated in FIG. 4, the method of FIG. 1 may determine a compensated red color luminance, a compensated green color luminance, and a compensated blue color luminance by applying weighted values to the red color luminance, the green color luminance, and the blue color luminance of the second display panel 20 according to the second RGB luminance ratio (S210), may adjust first currents flowing through organic light-emitting elements of red color display pixels of the second display panel 20 to implement (e.g., generate) the compensated red color luminance (S220), may adjust second currents flowing through organic light-emitting elements of green color display pixels of the second display panel 20 to implement (e.g., generate) the compensated green color luminance (S230), and may adjust third currents flowing through organic light-emitting elements of blue color display pixels of the second display panel 20 to implement (e.g., generate) the compensated blue color luminance (S240). Here, the method of FIG. 1 may adjust a current flowing through an organic light-emitting element of a pixel without compensation of data to be applied to the pixel by controlling power voltages ELVDD and ELVSS or by using an additional current source.

In another example embodiment, as illustrated in FIG. 5, the method of FIG. 1 may determine a compensated red color luminance, a compensated green color luminance, and a compensated blue color luminance by applying weighted values to the red color luminance, the green color luminance, and the blue color luminance of the first display panel 10 according to the first RGB luminance ratio (S310), may compensate first data to be applied to red color display pixels of the first display panel 10 to implement (e.g., generate) the compensated red color luminance (S320), may compensate second data to be applied to green color display pixels of the first display panel 10 to implement (e.g., generate) the compensated green color luminance (S330), and may compensate third data to be applied to blue color display pixels of the first display panel 10 to implement (e.g., generate) the compensated blue color luminance (S340). Similarly, as illustrated in FIG. 5, the method of FIG. 1 may determine a compensated red color luminance, a compensated green color luminance, and a compensated blue color luminance by applying weighted values to the red color luminance, the green color luminance, and the blue color luminance of the second display panel 20 according to the second RGB luminance ratio (S310). Further, the method may compensate first data to be applied to red color display pixels of the second display panel 20 to implement (e.g., generate) the compensated red color luminance (S320), may compensate second data to be applied to green color display pixels of the second display panel 20 to implement (e.g., generate) the compensated green color luminance (S330), and may compensate third data to be applied to blue color display pixels of the second display panel 20 to implement (e.g., generate) the compensated blue color luminance (S340). That is, the method of FIG. 1 may adjust a current flowing through an organic light-emitting element of a pixel by compensating data to be applied to the pixel. In some example embodiments, the method of FIG. 1 may adjust a current flowing through an organic light-emitting element of a pixel by controlling the power voltages ELVDD and ELVSS or by using the additional current source, while compensating the data to be applied to the pixel.

In brief, the method of FIG. 1 may drive the foldable display device that includes the first display panel 10 and the second display panel 20 that are foldable onto each other. Here, the method of FIG. 1 may effectively prevent (or reduce) the color shift phenomenon by which a color of an image displayed on the foldable display device is changed according to a direction in which the viewer gazes at the foldable display device (i.e., the first display panel 10 and the second display panel 20) by detecting the first gaze angle θ1 of the viewer with respect to the first display panel 10 and the second gaze angle θ2 of the viewer with respect to the second display panel 20, by determining the first RGB luminance ratio corresponding to the first gaze angle θ1 of the viewer and the second RGB luminance ratio corresponding to the second gaze angle θ2 of the viewer based on the mapping table that stores the expected gaze angles and the optimal RGB luminance ratios mapped to the expected gaze angles, by performing the first color shifting operation on the first display panel 10 based on the first RGB luminance ratio, and by performing the second color shifting operation on the second display panel 20 based on the second RGB luminance ratio. In some example embodiments, the method of FIG. 1 may not perform the first and second color shifting operations on the first and second display panels 10 and 20 when the folding angle θ3 between the first display panel 10 and the second display panel 20 is 180° (i.e., the foldable display device is completely unfolded) or when an image is displayed on either the first display panel 10 or the second display panel 20.

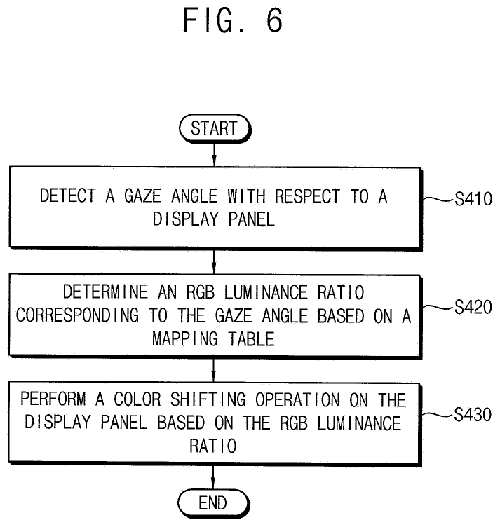

FIG. 6 is a flow diagram illustrating a method of driving a display device according to some example embodiments.

Referring to FIG. 6, the method of FIG. 6 may drive a display device (e.g., referred to as a non-foldable display device) including one display panel. For example, the method of FIG. 6 may detect a gaze angle of a viewer with respect to the display panel (S410), may determine an RGB luminance ratio corresponding to the gaze angle of the viewer based on a mapping table that stores expected gaze angles and optimal RGB luminance ratios mapped to the expected gaze angles (S420), and may perform a color shifting operation on the display panel based on the RGB luminance ratio (S430).

The method of FIG. 6 may detect the gaze angle of the viewer with respect to the display panel (S410). In an example embodiment, the method of FIG. 6 may detect a gaze of the viewer with respect to the display panel and may determine the gaze angle of the viewer as an angle between a normal line of the display panel and the gaze of the viewer. Here, the gaze of the viewer may be detected by a face recognition sensor that senses a face of the viewer and an iris recognition sensor that senses iris of the viewer. For example, the method of FIG. 6 may detect the gaze of the viewer by reflecting a location of the iris sensed by the iris recognition sensor on a gaze direction of the face sensed by the face recognition sensor, where the face recognition sensor and the iris recognition sensor are included in the display device. Next, the method of FIG. 6 may determine the RGB luminance ratio corresponding to the gaze angle of the viewer based on the mapping table that stores the expected gaze angles and the optimal RGB luminance ratios mapped to the expected gaze angles (S420). Here, the RGB luminance ratio indicates a ratio between a red color luminance, a green color luminance, and a blue color luminance that are mixed to implement (e.g., generate) a white color having a specific luminance. In addition, because the expected gaze angles and the optimal RGB luminance ratios mapped to the expected gaze angles are data obtained by the manufacturer of a display device by performing a simulation analysis, a test analysis, and/or the like on the display device, the mapping table that stores the expected gaze angles and the optimal RGB luminance ratios mapped to the expected gaze angles may be included in a memory device of the display device when the display device is manufactured. In an example embodiment, the method of FIG. 6 may search for an optimal RGB luminance ratio mapped to an expected gaze angle that corresponds to (e.g., matches or is consistent with) the gaze angle of the viewer in the mapping table and may choose the optimal RGB luminance ratio as the RGB luminance ratio for performing the color shifting operation on the display panel. In example embodiments, when there is not the expected gaze angle that corresponds to (e.g., matches or is consistent with) the gaze angle of the viewer in the mapping table, an interpolation technique may be employed.

Subsequently, the method of FIG. 6 may perform the color shifting operation on the display panel based on the RGB luminance ratio (S430). In an example embodiment, the method of FIG. 6 may determine a compensated red color luminance, a compensated green color luminance, and a compensated blue color luminance by applying weighted values to the red color luminance, the green color luminance, and the blue color luminance of the display panel according to the RGB luminance ratio. Further, the method may adjust first currents flowing through organic light-emitting elements of red color display pixels of the display panel to implement (e.g., generate) the compensated red color luminance, may adjust second currents flowing through organic light-emitting elements of green color display pixels of the display panel to implement (e.g., generate) the compensated green color luminance, and may adjust third currents flowing through organic light-emitting elements of blue color display pixels of the display panel to implement (e.g., generate) the compensated blue color luminance. Here, the method of FIG. 6 may adjust a current flowing through an organic light-emitting element of a pixel without compensation of data to be applied to the pixel by controlling power voltages ELVDD and ELVSS or by using an additional current source. In another example embodiment, the method of FIG. 6 may determine a compensated red color luminance, a compensated green color luminance, and a compensated blue color luminance by applying weighted values to the red color luminance, the green color luminance, and the blue color luminance of the display panel according to the RGB luminance ratio. Further, the method may compensate first data to be applied to red color display pixels of the display panel to implement (e.g., generate) the compensated red color luminance, may compensate second data to be applied to green color display pixels of the display panel to implement (e.g., generate) the compensated green color luminance, and may compensate third data to be applied to blue color display pixels of the display panel to implement (e.g., generate) the compensated blue color luminance. That is, the method of FIG. 6 may adjust a current flowing through an organic light-emitting element of a pixel by compensating data to be applied to the pixel. In brief, the method of FIG. 6 may drive the non-foldable (or flat) display device that includes one display panel. Here, the method of FIG. 6 may effectively prevent (or reduce) the color shift phenomenon by which a color of an image displayed on the non-foldable display device is changed according to a direction in which the viewer gazes at the non-foldable display device by detecting the gaze angle of the viewer with respect to the display panel, by determining the RGB luminance ratio corresponding to the gaze angle of the viewer based on the mapping table that stores the expected gaze angles and the optimal RGB luminance ratios mapped to the expected gaze angles, and by performing the color shifting operation on the display panel based on the RGB luminance ratio.

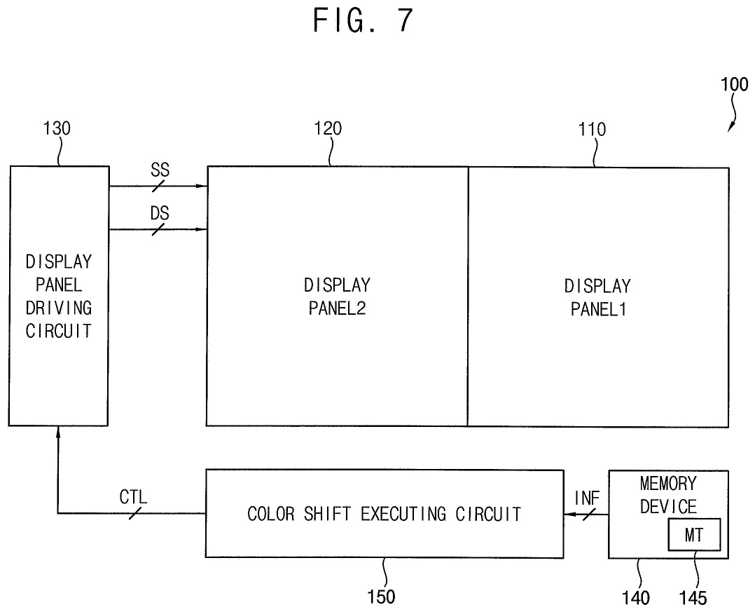

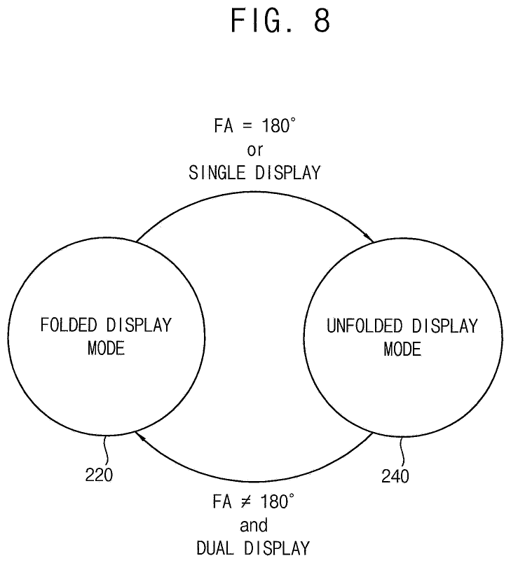

FIG. 7 is a block diagram illustrating a display device according to some example embodiments, and FIG. 8 is a diagram illustrating display modes of the display device of FIG. 7.

Referring to FIGS. 7 and 8, the display device 100 may include a first display panel 110, a second display panel 120, a display panel driving circuit 130, a memory device 140, and a color shift executing circuit 150. In an example embodiment, the display device 100 may be an organic light-emitting display (OLED) device.

Each of the first display panel 110 and the second display panel 120 may include a plurality of pixels. In an example embodiment, the pixels may include red color display pixels that output red color light, green color display pixels that output green color light, and blue color display pixels that output blue color light. In the first and second display panels 110 and 120, the pixels may be arranged in various manners (e.g., a matrix manner, a pentile manner, etc.). Here, the first display panel 110 and the second display panel 120 may be foldable onto each other. In other words, the first display panel 110 and the second display panel 120 may be folded onto each other or unfolded. The display panel driving circuit 130 may drive the first and second display panels 110 and 120. In an example embodiment, the display panel driving circuit 130 may include a scan driver, a data driver, a timing controller, and/or the like. The first and second display panels 110 and 120 may be connected to the scan driver via a plurality of scan-lines. The first and second display panels 110 and 120 may be connected to the data driver via a plurality of data-lines. The scan driver may provide a scan signal SS to the pixels included in the first and second display panels 110 and 120 via the scan-lines. The data driver may provide a data signal DS to the pixels included in the first and second display panels 110 and 120 via the data-lines. The timing controller may generate a plurality of control signals and may provide the control signals to the scan driver and the data driver to control the scan driver and the data driver. Here, the timing controller may perform a specific process (e.g., data compensation, and/or the like) on image data input from an external component. In some example embodiments, the display panel driving circuit 130 may further include an emission control driver. In this case, the emission control driver may be connected to the first and second display panels 110 and 120 via a plurality of emission control lines. Thus, the emission control driver may provide an emission control signal to the pixels included in the first and second display panels 110 and 120 via the emission control lines.

The memory device 140 may include a mapping table 145 that stores expected gaze angles and optimal RGB luminance ratios mapped to the expected gaze angles. As described above, an RGB luminance ratio indicates a ratio between a red color luminance, a green color luminance, and a blue color luminance that are mixed to implement (e.g., generate) a white color having a specific luminance. In addition, because the expected gaze angles and the optimal RGB luminance ratios mapped to the expected gaze angles are data obtained by the manufacturer of the display device 100 by performing a simulation analysis, a test analysis, and/or the like on the display panel 10, the mapping table 145 that stores the expected gaze angles and the optimal RGB luminance ratios mapped to the expected gaze angles may be included in the memory device 140 of the display device 100 when the display device 100 is manufactured. The color shift executing circuit 150 may detect a first gaze angle of a viewer with respect to the first display panel 110 and a second gaze angle of the viewer with respect to the second display panel 120, and may determine a first RGB luminance ratio corresponding to the first gaze angle of the viewer and a second RGB luminance ratio corresponding to the second gaze angle of the viewer based on the mapping table 145 that stores the expected gaze angles and the optimal RGB luminance ratios mapped to the expected gaze angles. Further, the color shift executing circuit 150 may perform a first color shifting operation on the first display panel 110 based on the first RGB luminance ratio, and may perform a second color shifting operation on the second display panel 120 based on the second RGB luminance ratio. In an example embodiment, the color shift executing circuit 150 may include a face recognition sensor that senses a face of the viewer and an iris recognition sensor that senses iris of the viewer. In this case, the color shift executing circuit 150 may detect the first and second gaze angles based on a gaze direction of the face sensed by the face recognition sensor and a location of the iris sensed by the iris recognition sensor. For example, the color shift executing circuit 150 may detect the first and second gaze angles of the viewer by reflecting the location of the iris sensed by the iris recognition sensor on the gaze direction of the face sensed by the face recognition sensor. In another example embodiment, the color shift executing circuit 150 may include a gyro sensor. In this case, the color shift executing circuit 150 may detect the first and second gaze angles of the viewer based on a folding angle between the first display panel 110 and the second display panel 120, which is sensed by the gyro sensor.

The color shift executing circuit 150 may provide a control signal CTL to the display panel driving circuit 130 to perform a first color shifting operation on the first display panel 110 and to perform a second color shifting operation on the second display panel 120. For example, the color shift executing circuit 150 may determine a compensated red color luminance, a compensated green color luminance, and a compensated blue color luminance by applying weighted values to red color luminance, green color luminance, and blue color luminance of the first display panel 110 according to a first RGB luminance ratio. The color shift executing circuit 150 may adjust first currents flowing through organic light-emitting elements of red color display pixels of the first display panel 110 or compensate first data to be applied to the red color display pixels of the first display panel 110 to implement (e.g., generate) the compensated red color luminance, may adjust second currents flowing through organic light-emitting elements of green color display pixels of the first display panel 110 or compensate second data to be applied to the green color display pixels of the first display panel 110 to implement (e.g., generate) the compensated green color luminance, and may adjust third currents flowing through organic light-emitting elements of blue color display pixels of the first display panel 110 or compensate third data to be applied to the blue color display pixels of the first display panel 110 to implement (e.g., generate) the compensated blue color luminance. Similarly, the color shift executing circuit 150 may determine a compensated red color luminance, a compensated green color luminance, and a compensated blue color luminance by applying weighted values to a red color luminance, a green color luminance, and a blue color luminance of the second display panel 120 according to a second RGB luminance ratio. The color shift executing circuit 150 may adjust first currents flowing through organic light-emitting elements of red color display pixels of the second display panel 120 or compensate first data to be applied to the red color display pixels of the second display panel 120 to implement (e.g., generate) the compensated red color luminance, may adjust second currents flowing through organic light-emitting elements of green color display pixels of the second display panel 120 or compensate second data to be applied to the green color display pixels of the second display panel 120 to implement (e.g., generate) the compensated green color luminance, and may adjust third currents flowing through organic light-emitting elements of blue color display pixels of the second display panel 120 or compensate third data to be applied to the blue color display pixels of the second display panel 120 to implement (e.g., generate) the compensated blue color luminance. Since these are described above, duplicated description related thereto may not be repeated.

In example embodiments, the display device 100 may change a display mode based on whether the foldable display panel including the first display panel 110 and the second display panel 120 is folded and whether an image is displayed on both the first display panel 110 and the second display panel 120. In an example embodiment, as illustrated in FIG. 8, the display device 100 may operate in a folded display mode 220 or in an unfolded display mode 240. Here, the folded display mode 220 indicates a display mode in which the folding angle between the first display panel 110 and the second display panel 120 is not 180° (e.g., indicated by FA≠180°) and an image is displayed on both the first display panel 110 and the second display panel 120 (e.g., indicated by DUAL DISPLAY). On the other hand, the unfolded display mode 240 indicates a display mode in which the folding angle between the first display panel 110 and the second display panel 120 is 180° (e.g., indicated by FA=180°) or an image is displayed on either the first display panel 110 or the second display panel 120 (e.g., indicated by SINGLE DISPLAY). For example, the unfolded display mode 240 may be referred to as a game mode because a user often unfolds the foldable display panel including the first display panel 110 and the second display panel 120 when the user plays an electronic game with the display device 100 and because the user often folds the foldable display panel including the first display panel 110 and the second display panel 120 to use either the first display panel 110 or the second display panel 120 when the user plays the electronic game with the display device 100. In an example embodiment, the color shift executing circuit 150 may operate in the folded display mode 220 but may not operate in the unfolded display mode 240. That is, because the color shift phenomenon rarely occurs in the unfolded display mode 240 in which the folding angle between the first display panel 110 and the second display panel 120 is 180° (i.e., the foldable display panel is completely unfolded) or an image is displayed on either the first display panel 110 or the second display panel 120, the display device 100 may prevent (or reduce) unnecessary power consumption due to operations of the color shift executing circuit 150 in the unfolded display mode 240 by controlling the color shift executing circuit 150 not to operate in the unfolded display mode 240.

In brief, the display device 100 may include the foldable display panel including the first display panel 110 and the second display panel 120 that are foldable onto each other. Here, the display device 100 may effectively prevent (or reduce) the color shift phenomenon by which a color of an image displayed on the display device 100 is changed according to a direction in which the viewer gazes at the display device 100 (i.e., the first display panel 110 and the second display panel 120) by detecting the first gaze angle of the viewer with respect to the first display panel 110 and the second gaze angle of the viewer with respect to the second display panel 120, by determining the first RGB luminance ratio corresponding to the first gaze angle of the viewer and the second RGB luminance ratio corresponding to the second gaze angle of the viewer based on the mapping table 145 that stores the expected gaze angles and the optimal RGB luminance ratios mapped to the expected gaze angles, by performing the first color shifting operation on the first display panel 110 based on the first RGB luminance ratio, and by performing the second color shifting operation on the second display panel 120 based on the second RGB luminance ratio. Thus, the display device 100 may provide a high-quality image to the viewer (or user).

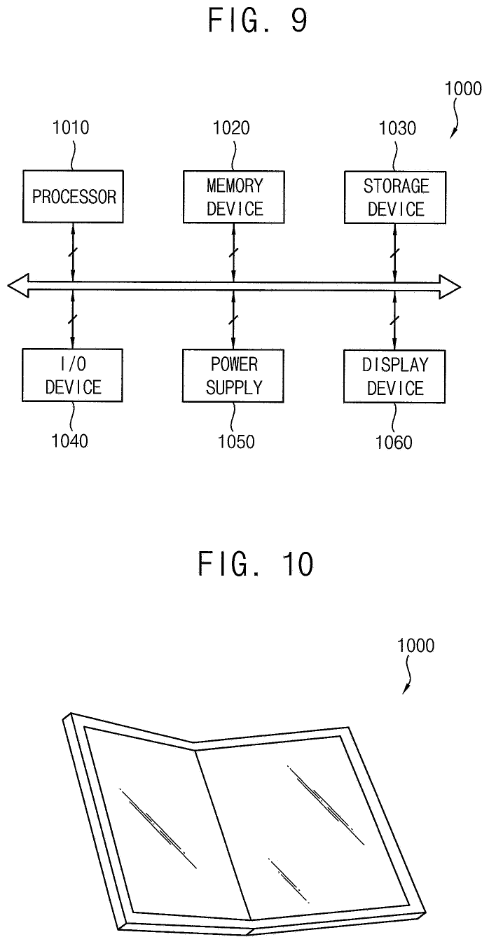

FIG. 9 is a block diagram illustrating an electronic device according to some example embodiments, and FIG. 10 is a diagram illustrating an example in which the electronic device of FIG. 9 is implemented as a smart pad.

Referring to FIGS. 9 and 10, the electronic device 1000 may include a processor 1010, a memory device 1020, a storage device 1030, an input/output (I/O) device 1040, a power supply 1050, and a display device 1060. Here, the display device 1060 may be the display device 500 of FIG. 7. In addition, the electronic device 1000 may further include a plurality of ports for communicating with a video card, a sound card, a memory card, a universal serial bus (USB) device, other electronic devices, and/or the like. In an example embodiment, as illustrated in FIG. 10, the electronic device 1000 may be implemented as a smart pad. However, the electronic device 1000 is not limited thereto. For example, the electronic device 1000 may be implemented as a cellular phone, a video phone, a smart phone, a smart watch, a tablet PC, a car navigation system, a computer monitor, a laptop, and/or the like.

The processor 1010 may perform various computing functions. The processor 1010 may be a microprocessor, a central processing unit (CPU), an application processor (AP), etc. The processor 1010 may be coupled to other components via an address bus, a control bus, a data bus, and/or the like. Further, the processor 1010 may be coupled to an extended bus such as a peripheral component interconnection (PCI) bus. The memory device 1020 may store data for operations of the electronic device 1000. For example, the memory device 1020 may include at least one non-volatile memory device such as an erasable programmable read-only memory

(EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. and/or at least one volatile memory device such as a dynamic random access memory (DRAM) device, a static random access memory (SRAM) device, a mobile DRAM device, etc. The storage device 1030 may include a solid state drive (SSD) device, a hard disk drive (HDD) device, a CD-ROM device, and/or the like. The I/O device 1040 may include an input device such as a keyboard, a keypad, a mouse device, a touch-pad, a touch-screen, etc., and an output device such as a printer, a speaker, etc. In some example embodiments, the I/O device 1040 may include the display device 1060. The power supply 1050 may provide power for operations of the electronic device 1000.

The display device 1060 may be coupled to other components via the buses or other communication links. In an example embodiment, the display device 1060 may be an organic light-emitting display device. As described above, the display device 1060 may effectively prevent (or reduce) a color shift phenomenon by which a color of an image displayed on the display device 1060 is changed according to a direction in which a viewer gazes at the display device 1060 (i.e., first and second display panels) by performing a first color shifting operation on the first display panel based on a first gaze angle of the viewer with respect to the first display panel and by performing a second color shifting operation on the second display panel based on a second gaze angle of the viewer with respect to the second display panel. Thus, the display device 1060 may provide a high-quality image to the viewer. For this operation, the display device 1060 may include the first display panel, the second display panel, a display panel driving circuit, a memory device, and a color shift executing circuit. The first display panel and the second display panel may be folded onto each other or unfolded. The display panel driving circuit may drive the first display panel and the second display panel. The memory device may include a mapping table that stores expected gaze angles and optimal RGB luminance ratios mapped to the expected gaze angles. The color shift executing circuit may detect the first gaze angle of the viewer with respect to the first display panel and the second gaze angle of the viewer with respect to the second display panel, may determine a first RGB luminance ratio corresponding to the first gaze angle of the viewer and a second RGB luminance ratio corresponding to the second gaze angle of the viewer based on the mapping table, may perform the first color shifting operation on the first display panel based on the first RGB luminance ratio, and may perform the second color shifting operation on the second display panel based on the second RGB luminance ratio. Here, the color shift executing circuit may operate in a folded display mode in which a folding angle between the first display panel and the second display panel is not 180° (i.e., the display device 1060 is folded by a specific folding angle) and an image is displayed on both the first display panel and the second display panel. On the other hand, the color shift executing circuit may not operate in an unfolded display mode in which the folding angle between the first display panel and the second display panel is 180 ° (i.e., the display device 1060 is completely unfolded) or an image is displayed on either the first display panel or the second display panel. Since these are described above, duplicated description related thereto may not be repeated.

The present inventive concept may be applied to a display device and an electronic device including the display device. For example, the present inventive concept may be applied to a cellular phone, a smart phone, a video phone, a smart pad, a smart watch, a tablet PC, a car navigation system, a television, a computer monitor, a laptop, an MP3 player, and/or the like.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the terms “use,” “using,” and “used” may be considered synonymous with the terms “utilize,” “utilizing,” and “utilized,” respectively.

The display device and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the display device may be formed on one integrated circuit (IC) chip or on separate IC chips. Further, the various components of the display device may be implemented on a flexible printed circuit film, a tape carrier package (TCP), a printed circuit board (PCB), or formed on a same substrate. Further, the various components of the display device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

The foregoing is illustrative of example embodiments and is not to be construed as limiting thereof. Although a few example embodiments have been described, those skilled in the art will readily appreciate that many modifications are possible in the example embodiments without materially departing from the novel teachings and aspects of the present inventive concept. Therefore, it is to be understood that modifications to the disclosed example embodiments, as well as other example embodiments, are intended to be included within the scope of the present invention as define by the appended claims, and equivalents thereof.

What is claimed is:

1. A method of driving a foldable display device comprising a first display panel and a second display panel that are foldable onto each other, the method comprising:
detecting a first gaze angle of a viewer with respect to the first display panel and a second gaze angle of the viewer with respect to the second display panel;
determining a first red, green, blue (RGB) luminance ratio corresponding to the first gaze angle and a second RGB luminance ratio corresponding to the second gaze angle based on a mapping table that stores expected gaze angles and optimal RGB luminance ratios mapped to the expected gaze angles;
performing a first color shifting operation on the first display panel based on the first RGB luminance ratio; and
performing a second color shifting operation on the second display panel based on the second RGB luminance ratio.

2. The method of claim 1, wherein the detecting the first gaze angle comprises:
detecting a first gaze of the viewer with respect to the first display panel; and
determining the first gaze angle as an angle between a normal line of the first display panel and the first gaze.

3. The method of claim 1, wherein the detecting the first gaze angle comprises:
sensing a folding angle between the first display panel and the second display panel using at least one sensing device; and
calculating the first gaze angle based on the folding angle.

4. The method of claim 1, wherein the detecting the second gaze angle comprises:
detecting a second gaze of the viewer with respect to the second display panel; and
determining the second gaze angle as an angle between a normal line of the second display panel and the second gaze.

5. The method of claim 1, wherein the detecting the second gaze angle comprises:
sensing a folding angle between the first display panel and the second display panel using at least one sensing device; and
calculating the second gaze angle based on the folding angle.

6. The method of claim 1, wherein the determining the first RGB luminance ratio comprises:
searching for a first optimal RGB luminance ratio mapped to a first expected gaze angle that corresponds to the first gaze angle in the mapping table; and
choosing the first optimal RGB luminance ratio as the first RGB luminance ratio.

7. The method of claim 1, wherein the determining the second RGB luminance ratio comprises:
searching for a second optimal RGB luminance ratio mapped to a second expected gaze angle that corresponds to the second gaze angle in the mapping table; and
choosing the second optimal RGB luminance ratio as the second RGB luminance ratio.

8. The method of claim 1, wherein the performing the first color shifting operation comprises:
determining a compensated red color luminance, a compensated green color luminance, and a compensated blue color luminance by applying weighted values to a red color luminance, a green color luminance, and a blue color luminance of the first display panel according to the first RGB luminance ratio;
adjusting first currents flowing through organic light-emitting elements of red color display pixels of the first display panel to implement the compensated red color luminance;
adjusting second currents flowing through organic light-emitting elements of green color display pixels of the first display panel to implement the compensated green color luminance; and
adjusting third currents flowing through organic light-emitting elements of blue color display pixels of the first display panel to implement the compensated blue color luminance.

9. The method of claim 1, wherein the performing the first color shifting operation comprises:
determining a compensated red color luminance, a compensated green color luminance, and a compensated blue color luminance by applying weighted values to a red color luminance, a green color luminance, and a blue color luminance of the first display panel according to the first RGB luminance ratio;
compensating first data to be applied to red color display pixels of the first display panel to implement the compensated red color luminance;
compensating second data to be applied to green color display pixels of the first display panel to implement the compensated green color luminance; and
compensating third data to be applied to blue color display pixels of the first display panel to implement the compensated blue color luminance.

10. The method of claim 1, wherein the performing the second color shifting operation comprises:
determining a compensated red color luminance, a compensated green color luminance, and a compensated blue color luminance by applying weighted values to a red color luminance, a green color luminance, and a blue color luminance of the second display panel according to the second RGB luminance ratio;
adjusting first currents flowing through organic light-emitting elements of red color display pixels of the second display panel to implement the compensated red color luminance;
adjusting second currents flowing through organic light-emitting elements of green color display pixels of the second display panel to implement the compensated green color luminance; and
adjusting third currents flowing through organic light-emitting elements of blue color display pixels of the second display panel to implement the compensated blue color luminance.

11. The method of claim 1, wherein the performing the second color shifting operation comprises:
determining a compensated red color luminance, a compensated green color luminance, and a compensated blue color luminance by applying weighted values to red color luminance, a green color luminance, and a blue color luminance of the second display panel according to the second RGB luminance ratio;
compensating first data to be applied to red color display pixels of the second display panel to implement the compensated red color luminance;
compensating second data to be applied to green color display pixels of the second display panel to implement the compensated green color luminance; and
compensating third data to be applied to blue color display pixels of the second display panel to implement the compensated blue color luminance.

12. A method of driving a display device comprising:
detecting a gaze angle of a viewer with respect to a display panel;
determining a red, green, blue (RGB) luminance ratio corresponding to the gaze angle based on a mapping table that stores expected gaze angles and optimal RGB luminance ratios mapped to the expected gaze angles; and
performing a color shifting operation on the display panel based on the RGB luminance ratio.

13. The method of claim 12, wherein the performing the color shifting operation comprises:
determining a compensated red color luminance, a compensated green color luminance, and a compensated blue color luminance by applying weighted values to a red color luminance, a green color luminance, and a blue color luminance of the display panel according to the RGB luminance ratio;
adjusting first currents flowing through organic light-emitting elements of red color display pixels of the display panel to implement the compensated red color luminance;
adjusting second currents flowing through organic light-emitting elements of green color display pixels of the display panel to implement the compensated green color luminance; and
adjusting third currents flowing through organic light-emitting elements of blue color display pixels of the display panel to implement the compensated blue color luminance.

14. The method of claim 12, wherein the performing the color shifting operation comprises:
determining a compensated red color luminance, a compensated green color luminance, and a compensated blue color luminance by applying weighted values to a red color luminance, a green color luminance, and a blue color luminance of the display panel according to the RGB luminance ratio;
compensating first data to be applied to red color display pixels of the display panel to implement the compensated red color luminance;
compensating second data to be applied to green color display pixels of the display panel to implement the compensated green color luminance; and
compensating third data to be applied to blue color display pixels of the display panel to implement the compensated blue color luminance.

15. A display device comprising:
a foldable display panel comprising a first display panel and a second display panel that are foldable onto each other;
a display panel driving circuit configured to drive the first display panel and the second display panel;
a memory device configured to record a mapping table that stores expected gaze angles and optimal red, green, blue (RGB) luminance ratios mapped to the expected gaze angles; and
a color shift executing circuit configured to detect a first gaze angle of a viewer with respect to the first display panel and a second gaze angle of the viewer with respect to the second display panel, to determine a first RGB luminance ratio corresponding to the first gaze angle and a second RGB luminance ratio corresponding to the second gaze angle based on the mapping table, to perform a first color shifting operation on the first display panel based on the first RGB luminance ratio, and to perform a second color shifting operation on the second display panel based on the second RGB luminance ratio.

16. The display device of claim 15, wherein the color shift executing circuit comprises a face recognition sensor configured to sense a face of the viewer and an iris recognition sensor configured to sense an iris of the viewer, and
wherein the color shift executing circuit detects the first and second gaze angles based on a gaze direction of the face sensed by the face recognition sensor and a location of the iris sensed by the iris recognition sensor.

17. The display device of claim 15, wherein the color shift executing circuit comprises a gyro sensor configured to sense a folding angle between the first display panel and the second display panel, and
wherein the color shift executing circuit is configured to detect the first and second gaze angles based on the folding angle between the first display panel and the second display panel.

18. The display device of claim 15, wherein the color shift executing circuit is configured not to operate in an unfolded display mode in which a folding angle between the first display panel and the second display panel is 180° or when an image is displayed on either the first display panel or the second display panel.

19. The display device of claim 15, wherein the color shift executing circuit is configured to determine a compensated red color luminance, a compensated green color luminance, and a compensated blue color luminance by applying weighted values to a red color luminance, a green color luminance, and a blue color luminance of the first display panel according to the first RGB luminance ratio, to adjust first currents flowing through organic light-emitting elements of red color display pixels of the first display panel or to compensate first data to be applied to the red color display pixels to implement the compensated red color luminance, to adjust second currents flowing through organic light-emitting elements of green color display pixels of the first display panel or to compensate second data to be applied to the green color display pixels to implement the compensated green color luminance, and to adjust third currents flowing through organic light-emitting elements of blue color display pixels of the first display panel or to compensate third data to be applied to the blue color display pixels to implement the compensated blue color luminance.

20. The display device of claim 15, wherein the color shift executing circuit is configured to determine a compensated red color luminance, a compensated green color luminance, and a compensated blue color luminance by applying weighted values to a red color luminance, a green color luminance, and a blue color luminance of the second display panel according to the second RGB luminance ratio, to adjust first currents flowing through organic light-emitting elements of red color display pixels of the second display panel or to compensate first data to be applied to the red color display pixels to implement the compensated red color luminance, to adjust second currents flowing through organic light-emitting elements of green color display pixels of the second display panel or to compensate second data to be applied to the green color display pixels to implement the compensated green color luminance, and to adjust third currents flowing through organic light-emitting elements of blue color display pixels of the second display panel or to compensate third data to be applied to the blue color display pixels to implement the compensated blue color luminance.
